(19) United States
(12) Patent Application Publication
(10) Pub. No.: US 2014/0113272 A1
(43) Pub. Date: Apr. 24, 2014

(54) CHALKBOARD PAINTED GLASSWARE PRODUCTION PROCESS, PRODUCT MADE THEREBY, AND METHOD OF USING THE PRODUCT

(71) Applicant: JENNIFER SCHEFKE, Presque Isle, MI (US)

(72) Inventor: JENNIFER SCHEFKE, Presque Isle, MI (US)

(21) Appl. No.: 13/654,605

(22) Filed: Oct. 18, 2012

(51) Int. Cl. C03C 17/00; B43L 1/10; B65D 1/40

(52) U.S. Cl. CPC C03C 17/005; B65D 1/40; B43L 1/10
USPC 434/408; 206/459.5; 427/287

(57) ABSTRACT

The base of glassware is hand painted with chalkboard paint. The purpose of the chalkboard painted glass is for the person using the glass to be able to identify her or his glass, or its contents. After being hand painted, the glass is heat cured in an oven for durability. The user can then use chalk to label the base of the glass. The chalk erases from the base with a damp cloth or sponge. The glasses are dishwasher safe.

### BACKGROUND OF THE INVENTION

The present invention relates generally to a chalkboard painted glassware production process, a product made thereby, and a method of using the product.

More particularly, the present invention relates to the process, product, and method mentioned hereinabove to enable the user of the glass to identify the glass and/or its contents.

It is a desideratum of the present invention is to avoid the animadversion, disadvantages and deficiencies of conventional glassware and techniques, and to provide novel glassware and processes of making and using same.

### SUMMARY OF THE INVENTION

The present invention provides a chalkboard painted glassware production process, comprising the steps of: washing the glassware to be painted; rinsing the washed glassware; placing the rinsed glassware upside down to dry; transporting the dried glassware to an area for hand painting; wiping the base of said glassware with a soft cloth saturated with rubbing alcohol; hand painting the base of the dried glassware with a first coat of chalkboard paint; placing the painted glassware upside down; air drying said painted glassware at room temperature for a first predetermined period of time; hand painting said base of said painted glassware with a second coat of the chalkboard paint; placing the painted glassware upside down; air drying said painted glassware at room temperature for a second predetermined period of time; placing said painted glassware upside down in an oven; heat curing said painted glassware in said oven at a predetermined temperature for a third predetermined period of time; turning off said oven; allowing said glassware to remain in said oven until said glassware to cool down to room temperature; removing said glassware from said oven; and cleaning said glassware to remove any fingerprints and/or debris.

The present invention also provides a product produced by the process described hereinabove.

The present invention also provides a method of using the product produced by the process described hereinabove, comprising the step of writing or drawing with chalk on the painted area on the glassware.

An object of the present invention is to provide glasses of all shapes and sizes, such as, for example, wine glasses and martini glasses, which are hand painted with chalkboard paint at least on the base of the glass.

Another object of the present invention is to provide a glass which enables: the user thereof to identify her or his glass; a host to place messages/designs on each glass; the user to identify and differentiate beverages.

Other objects, advantages, and features of the present invention will become apparent to those persons skilled in this particular area of technology and to other persons after having been exposed to the present patent application.

### BRIEF DESCRIPTION OF THE DRAWINGS

FIG. 1 illustrates an unpainted wine glass.

FIG. 2 depicts the FIG. 1 wine glass being hand painted with chalkboard paint.

FIG. 3 shows the FIG. 1 wine glass whose base and bottom ¼ stem portion have been hand painted with chalkboard paint.

FIG. 4 illustrates the FIG. 3 wine glass resting on a cookie sheet in a heat curing oven.

FIG. 5 is a perspective view of the final wine glass with a name, word(s), and or design(s) chalked on its chalkboard painted base.

FIG. 6 shows the FIG. 5 wine glass with a sponge for wiping off the name.

FIG. 7 illustrates a martini glass in a view similar to FIG. 5.

FIG. 8 shows the FIG. 7 martini glass in a view similar to FIG. 6.

### DETAILED DESCRIPTION OF THE INVENTION

With reference to the drawings, there is illustrated a chalkboard painted glassware production process and method of using same in accordance with the present invention.

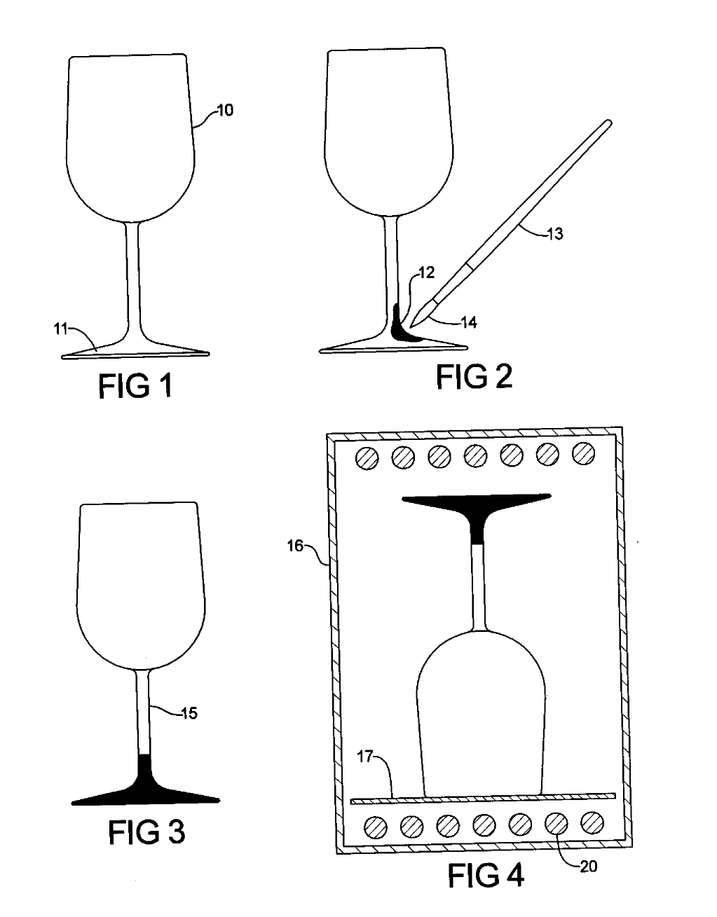

The glassware 10 shown in FIG. 1 is washed by submersing it in a sink filled with hot water and dish soap.

After submersion the glassware 10 is washed by hand with a soft cloth.

The glassware 10 is then rinsed off with hot water, and placed on a towel upside down to air dry.

After the glassware 10 has dried, it is then placed back into its respective case for transport to the area for which it is to be hand painted.

Prior to the painting process, a soft cloth is saturated in rubbing alcohol and used to wipe the base 11 of the glassware 10 to which the paint 12 will be applied.

With reference to FIG. 2, the paint brush 13 used has soft bristles 14 that are approximately ¾″ in length and are positioned at approximately a 45 degree angle.

Preferably, but not necessarily, the paint 12 used is Porcelaine 150 Chalkboard Black Paint manufactured by Pebeo.

The prepared glassware 10 is held in one hand while the other hand holds the paint brush 13 and dips the brush into the abovementioned chalkboard paint 12 just enough to submerge ¼ of the bristles 14 into the container holding the supply of paint.

The brush 13 is then dragged across the lip of the paint container to remove excess paint.

The paint 12 is then applied to the glassware 10 using smooth strokes and taking care not to create any running of the paint 12.

With reference to FIGS. 2 and 3, the bottom ¼ portion of the stem 15 of the glassware 10 and the base 11 of the glassware 10 are covered with a thin coat of paint 12.

The glassware 10 is then placed upside down and allowed to air dry at room temperature for 24 hours.

After the 24-hour drying time, a second coat of paint 12 is applied to the glassware 10 in the same manner as the first coat of paint 12.

The glassware 10 is then again placed upside down and allowed to air dry at room temperature for 24 hours.

Once the glassware 10 has been dried for 24 hours for the second time, it is now ready to be heat cured.

Two separate standard kitchen ovens 16 (only one of which is illustrated in FIG. 4) are used for the heat curing process.

While the ovens 16 are off, flat cooking sheets 17 are placed on top of the oven grates 20.

Approximately forty-eight of the hand painted glasses 10 are then inverted and placed on the cooking sheets 17 in the ovens 16.

A cooking thermometer is placed in the ovens 16 for close monitoring of the temperatures.

The oven doors are closed, the ovens 16 are then turned on, and the temperature dials are set at approximately 300 degrees Fahrenheit.

Once the oven temperatures reaches approximately 300 degrees Fahrenheit, a timer is set for 35 minutes.

When the timer alerts that the 35 minutes has passed, the ovens 16 are turned off and the glassware 10 is left in the ovens 16 until they cool down to room temperature.

After the glassware 10 has cooled down to room temperature, they are removed from the ovens 16 and cleaned with glass cleaner to remove any fingerprints or debris they may have acquired during the production process.

The painted glassware 10 is now completed and ready for use.

To use the chalkboard hand painted glassware, the individual in possession of the glassware may take a piece of standard white chalk or colored chalk and write or draw whatever she or he may choose on the painted area 17 of the glass 10.

This is illustrated by the word “NAME” 18 in FIG. 5 to indicate the name of the individual.

This aids the individual in identifying her or his glass, and/or its contents.

Alternatively, perhaps someone is hosting a party and the host chooses to write messages to the guests on the glassware 10.

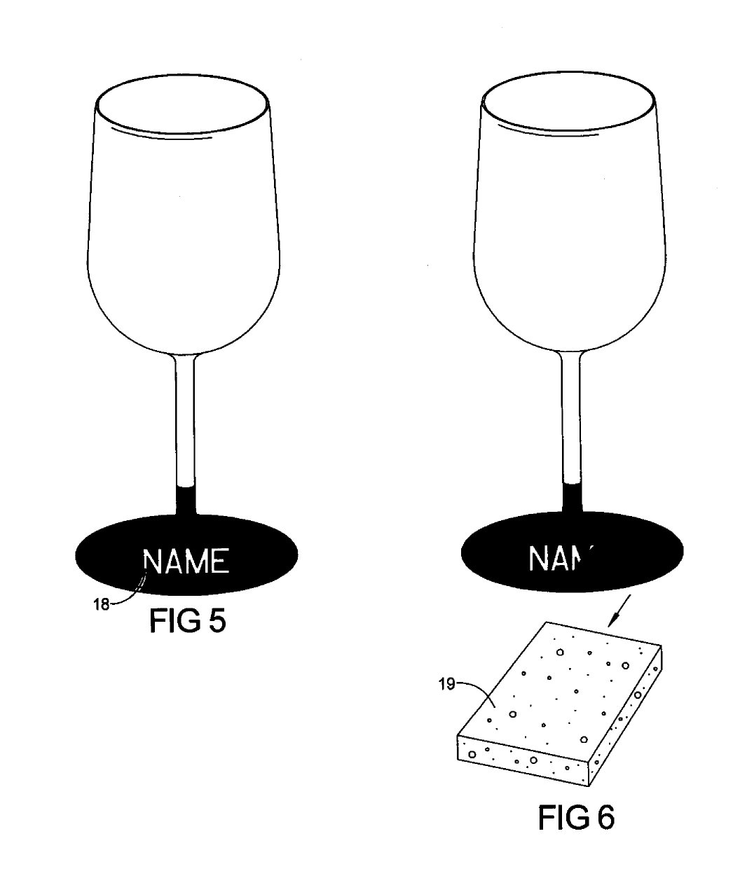

With reference to FIG. 6, cloth or sponge 19 dampened with water may be used to remove the chalk from the glassware if the user chooses to write or draw something else on her or his glassware 10.

The glassware 10 may be rated dishwasher safe. However hand washing is recommended due to the fragile nature of the glassware 10.

Both of the ovens 16 used for the manufacturing process are General Electric. The model number for the first one is JBP24G002WH serial number RG208142G. The model number for the second oven is JBS25001HA serial number HA170806G.

The brushes used are Loew-Cornell soft comfort TM/MC Ang Shader U.S. Pat. No. D458,761.

The present invention relates to a broad range of glassware, only some of which are mentioned hereinbelow.

Some colored wine glasses are 18.5 ounces and manufactured by Famous-Maker.

Some large clear wine glasses are 20 ounces, and smaller clear wine glasses are 10 ounces.

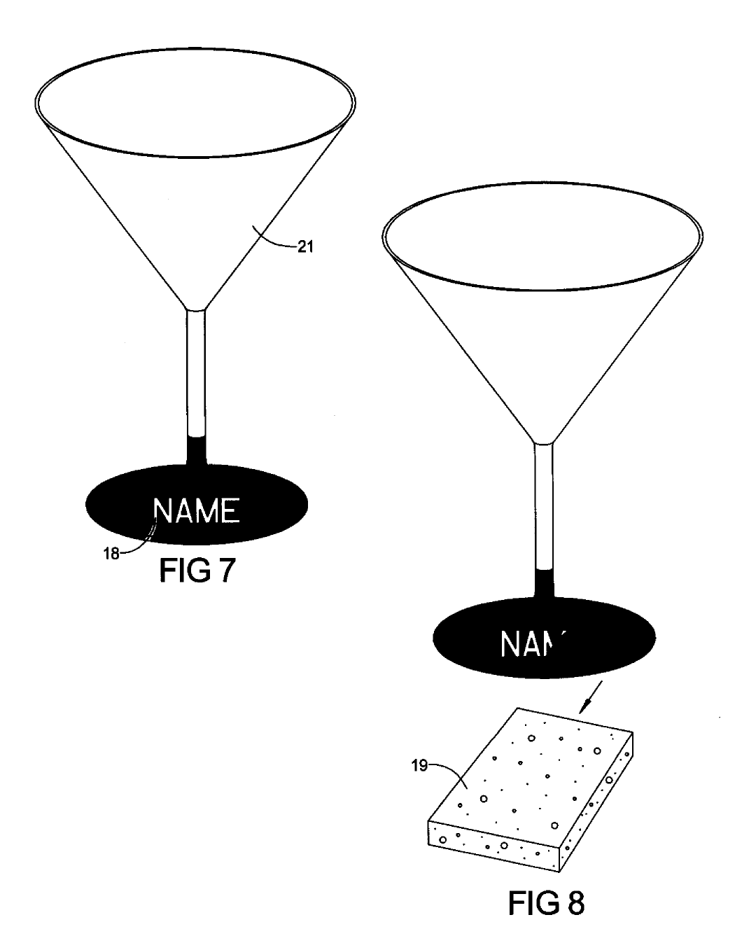

The present invention also applies to other types of glassware, such as, for example, 12-ounce green and blue martini glasses 21 manufactured by Famous-Maker. In this connection, attention is directed to FIGS. 7 and 8.

Although brush painting has been described hereinabove and is the preferred method of applying the chalkboard paint, the present invention also covers chalkboard paint applied by spray painting.

There have been described hereinabove and illustrated in the accompanying patent drawings, only some of the many possible embodiments of the present invention which can be practiced in many different ways.

Many changes, modifications, variations, and other uses and applications will become apparent to those persons skilled in this particular area of technology and to others after having been exposed to the present patent application.

Any and all such changes, modifications, variations and other uses and applications which do not depart from the spirit and scope of the present invention are therefore covered by and embraced within the patent claims set forth hereinbelow.

1. A chalkboard painted glassware production process, comprising the steps of:
washing the glassware to be painted;
rinsing the washed glassware;
placing the rinsed glassware upside down to dry;
transporting the dried glassware to an area for hand painting;
wiping the base of said glassware with a soft cloth saturated with rubbing alcohol;
hand painting the base of the dried glassware with a first coat of chalkboard paint;
placing the painted glassware upside down;
air drying said painted glassware at room temperature for a first predetermined period of time;
hand painting said base of said painted glassware with a second coat of the chalkboard paint;
placing the painted glassware upside down;
air drying said painted glassware at room temperature for a second predetermined period of time;
placing said painted glassware upside down in an oven;
heat curing said painted glassware in said oven at a predetermined temperature for a third predetermined period of time;
turning off said oven;
allowing said glassware to remain in said oven until said glassware to cool down to room temperature;
removing said glassware from said oven; and
cleaning said glassware to remove any fingerprints and/or debris.

2. The process of claim 1, wherein:
after transporting the dried glassware to said area for hand painting;
wiping the base and the bottom ¼ portion of the stem of said glassware with a soft cloth saturated with rubbing alcohol;
hand painting the base and said bottom ¼ portion of the stem of the dried glassware with a first coat of chalkboard paint;
placing the painted glassware upside down;
air drying said painted glassware at room temperature for a first predetermined period of time; and
hand painting said base and said bottom ¼ portion of said stem of said painted glassware with a second coat of the chalkboard paint.

3. The process of claim 1, wherein:
said step of cleaning said glassware to remove any fingerprints and/or debris is done with glass cleaner.

4. The process of claim 2, wherein:
said step of cleaning said glassware to remove any fingerprints and/or debris is done with glass cleaner.

5. The process of claim 1, wherein:
said first predetermined period of time is approximately twenty-four hours.

6. The process of claim 1, wherein:
said second predetermined period of time is approximately twenty-four hours.

7. The process of claim 2, wherein:
said second predetermined period of time is approximately twenty-four hours.

8. The process of claim 1, wherein:
said first predetermined temperature is approximately 300 degrees Fahrenheit.

9. The process of claim 2, wherein:
said first predetermined temperature is approximately 300 degrees Fahrenheit.

10. The process of claim 3, wherein:
said first predetermined temperature is approximately 300 degrees Fahrenheit.

11. The process of claim 4, wherein:
said first predetermined temperature is approximately 300 degrees Fahrenheit.

12. The process of claim 1, wherein:
said third predetermined period of time is approximately thirty-five minutes.

13. The process of claim 8, wherein:
said third predetermined period of time is approximately thirty-five minutes.

14. The process of claim 9, wherein:
said third predetermined period of time is approximately thirty-five minutes.

15. The process of claim 10, wherein:
said third predetermined period of time is approximately thirty-five minutes.

16. The process of claim 11, wherein:
said third predetermined period of time is approximately thirty-five minutes.

17. The process of claim 1, wherein:
said hand painting is done with a paint brush having soft bristles which are approximately three quarters of an inch in length and positioned at a 45 degree angle.

18. A product produced by the process of claim 1.

19. A method of using the product produced by the process of claim 1, comprising the step of:
writing or drawing with chalk on the painted area on the glassware.

20. The method of claim 19, including the step of:
removing the chalk writing or drawing from the painted area of the glassware.
